(19) United States
(12) Patent Application Publication
(10) Pub. No.: US 2009/0308720 A1
(43) Pub. Date: Dec. 17, 2009

(54) TILT SWITCH

(75) Inventors: CHUAN-HONG WANG, Tu-Cheng (TW); LI-ZHANG HUANG, Tu-Cheng (TW); HSIAO-CHUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/353,975

(22) Filed: Jan. 15, 2009

(30) Foreign Application Priority Data
Jun. 11, 2008 (CN) 200810302095.7

(51) Int. Cl. H01H 35/02

(52) U.S. Cl. 200/61.52

(57) ABSTRACT

A tilt switch is provided. The tilt switch comprises a housing, a cap, a conductive ball, and a plurality of contact terminals. A chamber is formed in the housing and is defined by a bottom surface and a surrounding surface. The cap is attached above the chamber. The plurality of contact terminals extends from the cap to the bottom surface and protruding out of the chamber. The electrically conductive ball is placed in a space defined by the cap, the bottom surface, and the plurality of contact terminals and is capable of simultaneously contacting with at most two of the plurality of contact terminals.

### BACKGROUND

1. Technical Field

The present invention relates to a tilt switch having a rollable ball therein.

2. General Background

Referring to FIGS. 4 and 5, a tilt switch 10 is shown to include an insulating housing 11 with an chamber therein for rollably receiving an electrically conductive ball 12. Two pairs of first and second electric contact terminals 13 are press-fitted to a bottom plug 14, and have upper tip ends 131 extending into the chamber of the housing 11 when the plug 14 is secured to a bottom opening 111 of the housing 11 by virtue of engagement between protrusions 112 and recesses 142. Lower tip ends 132 of the terminals 13 are soldered to an electric contact member of a support (not shown). When the tilt switch 10 is mounted on the support, which stands on a horizontal plane 20, the ball 12 contacts the upper tip ends 131 to make an electrical connection between the first and second electric contact terminals 13. Once the support is tilted, the ball 12 will roll away from the terminals 13 to break the electrical connection.

The housing 11 has an inner peripheral wall surface 115 extending uprightly to confine the elongated accommodating chamber such that the ball 12 is rollable thereon. It is noted that the movement of the ball 12 is somehow difficult to move away from the terminals 13 in the state that the housing 11 is not tilted down completely, thereby resulting in lack of safety during use.

Accordingly, there is a need to provide a tilt switch to solve the problem aforementioned.

### BRIEF DESCRIPTION OF THE DRAWINGS

FIG. 1 is an isometric, exploded view of a tilt switch in accordance with one embodiment of the present invention.

FIG. 2 is an assembled, cross-sectional view of the tilt switch of FIG. 1, taken from the line II-II in FIG. 1.

FIG. 3 is a plan view of the tilt switch of FIG. 1, with a cap omitted.

FIG. 4 is an exploded view of a related-art tilt switch.

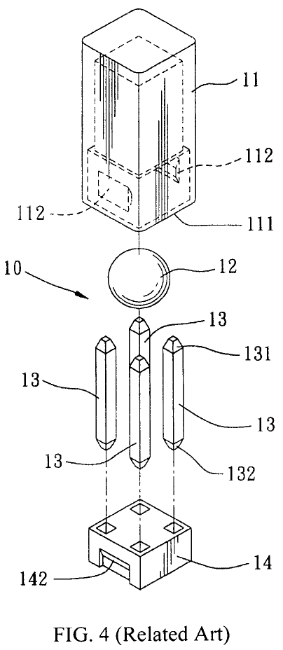

FIG. 5 is a cross-sectional view of the related-art tilt switch of FIG. 4.

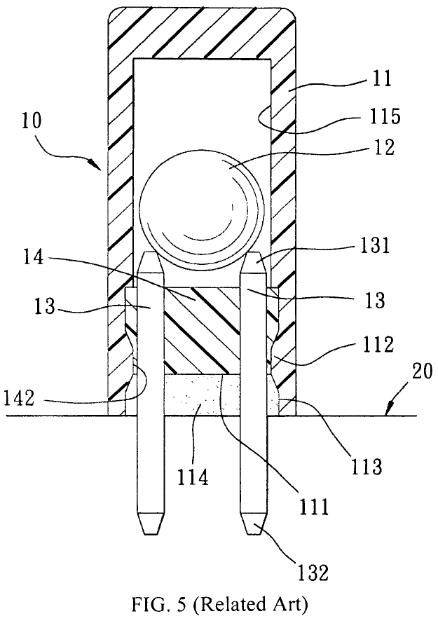

### DETAILED DESCRIPTION OF THE EMBODIMENTS

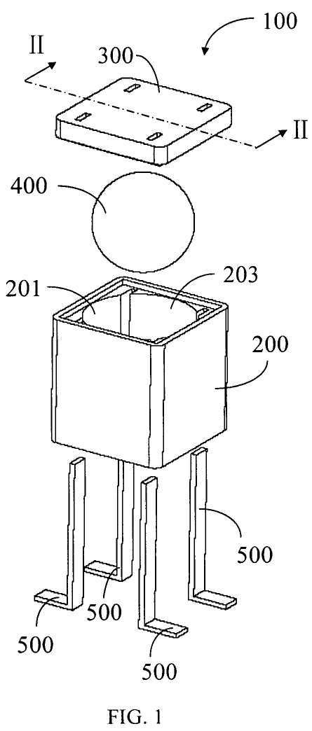

FIG. 1 shows a tilt switch 100 in accordance with one exemplary embodiment of the present invention. The tilt switch 100 includes a housing 200, a cap 300, a conductive ball 400, and a plurality of contact terminals 500.

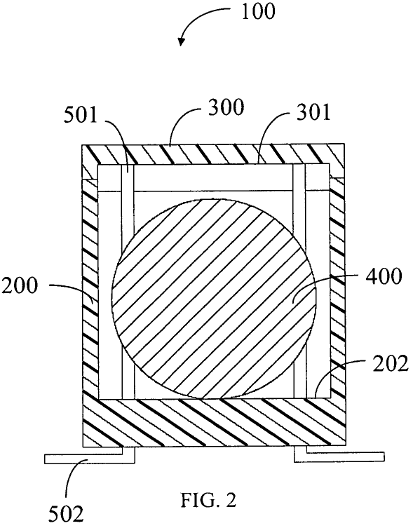

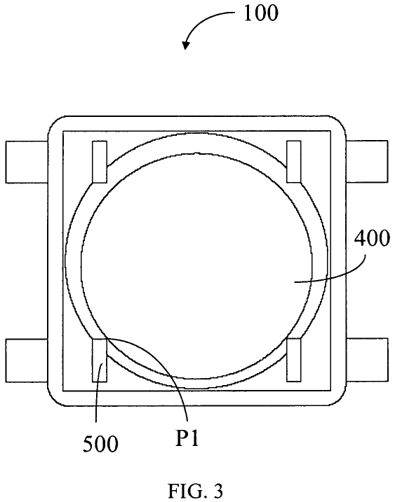

Referring to FIGS. 2 and 3, the housing 200 is made of electrically insulating material. A chamber 201 is formed in the housing 200 and is defined by a bottom surface 202 and a surrounding wall 203. The cap 300 is attached above the chamber 201 and includes a top surface 301 that is opposite to the bottom surface 202.

Each contact terminal 500 is generally L shaped and extends through the chamber 201. Specifically, each contact terminal 500 includes an inside portion 501 and an outside portion 502. The inside portion 501 extends from the cover portion 300 to the bottom surface 202. The outside portion 502 is generally perpendicular to the inside portion 501 and can be soldered to a circuit board (not shown). In one embodiment, the plurality of contact terminals and the housing are integrally constructed by plastic injection molding.

The conductive ball 400 is placed in the chamber 201 and can be rollable in the chamber 201. Specifically, the conductive ball 400 is placed in a space that is defined by the plurality of contact terminals 500, the top surface 301, and the bottom surface 202. The conductive ball 400 and the plurality of contact terminals 500 are configured in such a way that the conductive ball is capable of simultaneously contacting with at most two of the plurality of the contact terminals 500. In an exemplary embodiment, the conductive ball 400 is coated with copper or made of copper.

When in use, the tilt switch 100 is mounted horizontally, with the inside portions 501 of the contact terminals 500 generally parallel to the ground. With the tilt switch 100 in such an initial position as shown in FIG. 3, the conductive ball 400 is supported by two lower contact terminals 500, thereby forming an electrical connection between the contact terminals 500.

The conductive ball 400 stays in contact with the two contact terminals 500 until the housing 200 is tilted leftwards or rightwards from the initial position to at least a predetermined angle. Specifically, for example, in the process of tilting the housing 200 leftwards, a gravitational torque about a support point P1 of the contact terminal 500 acts on the conductive ball 400. The gravitational torque continues decreasing until the housing 200 is tilted to the predetermined angle and becomes zero when the gravity of the conductive ball 400 acts through the support point P1. In the present embodiment, the predetermined angle is about 45 degrees.

Before the housing 200 tilts to the predetermined angle, the gravitational torque prevents the conductive ball 400 from rolling around the support point P1. After the housing 200 has tilted to the predetermined angle, the gravitational torque pulls the conductive ball to roll around the support point P1 until the conductive ball is supported by another pair of contact terminals.

The tilt switch 100 can be used in an upright standing appliance, such as a light stand, fan, heater, etc. In an exemplary embodiment, two tilt switches 100 are used in an upright standing appliance, one for detecting tilt occurred leftwards and rightwards, the other for detecting tilt occurred leftwards forwards and backwards. By detecting electrical connection of another pair of contact terminals, the upright standing appliance determines if it has leaned and can thus cut off power for safety.

What is claimed is:

1. A tilt switch comprising:
an electrically insulating housing with a chamber formed therein, wherein the chamber is defined by a bottom surface and a surrounding surface;
a cap attached above the chamber;
a plurality of contact terminals extending from the cap to the bottom surface and protruding out of the chamber;
an electrically conductive ball placed in a space defined by the cap, the bottom surface, and the plurality of contact terminals, wherein the electrically conductive ball is capable of simultaneously contacting with at most two of the plurality of contact terminals.

2. The tilt switch according to claim 1, wherein the number of the plurality of contact terminals is four.

3. The tilt switch according to claim 1, wherein each of the contact terminals is L shaped.

4. The tilt switch according to claim 1, wherein the housing and the plurality of contact terminals are integrally constructed by plastic injection molding.

5. The tilt switch according to claim 1, wherein the conductive ball is coated with copper.

6. The tilt switch according to claim 1, wherein the conductive ball is made of copper.
